(19) United States
(12) Patent Application Publication
(10) Pub. No.: US 2002/0141835 A1
(43) Pub. Date: Oct. 3, 2002

(54) Method for determining uncertainties for printed circuit board drilling machines

(76) Inventor: Klay Herbert, Oberwil (CH)

Correspondence Address: Richard K. Robinson, Attorney at Law, North Dallas Bank Tower, Suite 1202, 12900 Preston Road, LB-41, Dallas, TX, 75230, US

(21) Appl. No.: 10/103,379

(22) Filed: Mar. 21, 2002

(30) Foreign Application Priority Data
Apr. 2, 2001 (EP) 01201248.0

(51) Int. Cl. B23B 35/00

(52) U.S. Cl. 408/1 R

(57) ABSTRACT

There is disclosed a method for determining the position of positioning means (12, 13, 14) with respect to a known reference, intended to be implemented on a machine-tool (1) for machining printed circuit boards, of the type including in particular a workpiece carrier (3) and at least a motorised spindle (8) carrying a tool (6). Said machine-tool (1) further includes a control unit including in particular programmable electronic means allowing the method according to the invention to be implemented automatically, by moving said motorised spindle (8) and detecting electromagnetic or electric interactions between said tool (6) and said positioning means (12, 13, 14).

The present invention concerns a method for determining uncertainty as to the position of positioning means for printed circuit boards with respect to a reference position for a machine-tool, in particular of the printed circuit board drilling machine tool type said machine including means for positioning said boards with respect to an operating unit and programmable electronic control means for said machine.

Known machine-tools for machining and in particular for drilling printed circuit boards essentially include a base section, a workpiece carrier or worktable mounted on the base section and onto which said printed circuit boards to be machined and/or drilled are secured. Said machines further include at least an operating unit in which is situated, for example, a motorised spindle for receiving a cutting tool, such as a drill bit, and electromechanical means allowing said operating unit to move relative to the workpiece carrier in conjunction with a control circuit.

Generally, the workpiece carrier and the operating unit can be moved relative to each other in two perpendicular directions, while the operating unit can also be moved in a third direction, perpendicular to the two others in order to define, for example, the depth of drilling . As a general rule, these machines include several operating units to be able to machine several boards or stacks of printed circuit boards at the same time.

Commonly, these stacks of printed circuit boards include a support or base plate, a stack of plates to be drilled and a cover or entry plate. These latter are generally held together by pins which are also used, on the one hand as a positioning reference for the printed circuit boards in relation to each other and, on the other hand, for positioning said stacks on the workpiece carrier.

The density of the holes drilled in such printed circuit boards may reach high values, of the order of several tens of holes per square centimeter, which requires the operator of such a machine-tool to position said pins on the workpiece carrier with great precision, so as to take account of predefined tolerances of the manufacturing process.

This requirement for precision constitutes a significant drawback for the operator to the extent that he is obliged to check regularly that the position of said pins is within the limit of admissible tolerances. Indeed, a failure to respect these tolerances as to the position of the pins may have disastrous consequences for a printed circuit manufacturer, such as making stacks of printed circuits drilled in such conditions useless, because of poor positioning of the holes.

The absolute precision requirement is all the more penalising, in terms of costs and rate of use, for the operator of a machine-tool of this type operating in accordance with the principle of the prior art, as measuring of the exact position of said pins is usually carried out manually. Determination of the uncertainty of the position of the pins, which is deduced from said measurement, thus takes a while during which time the machine cannot be used to machine stacks of circuits. Furthermore, said determination forces the operator of such a machine to keep an operator available while said machine is operating, in order to be able to carry out periodic checks of said uncertainty between two machining sequences and where necessary correction operations.

The main object of the present invention is thus to overcome the drawbacks of the aforementioned prior art by providing a method for determining uncertainty as to the position of positioning means which is quicker and less expensive than those implemented in the prior art.

The invention therefore concerns a method for determining uncertainty of the type mentioned hereinbefore, characterised in that the determination of said uncertainty is performed automatically by implementing said programmable electronic means.

Thus, the method according to the invention allows the operator of such a machine to ease the workload of the operator normally in charge of performing checks on the machines of the prior art and thus to lower the production costs. Moreover, the method according to the invention allows its operator to save time on production speed, insofar as it is performed automatically by the same machine as that used to machine the printed circuit boards.

In a preferred embodiment of the invention, in which said operating unit includes a spindle holding a tool, such as a drill bit, the method includes the steps consisting in:

a) applying a first electric potential to the drill bit and a second electric potential, of different value to that of the first potential, to at least a zone of limited spatial size of said positioning means,

b) measuring the electric potential of the drill bit so as to detect any change in its value,

c) moving said spindle to a distance from said zone so that a modification in the value of said first potential occurs because of its interaction with said second electric potential, said distance having been predetermined once and for all as a function of the nature of the drill bit and the potentials used,

d) measuring accurately the position of said spindle, then that of the drill bit, at the moment of said modification in value of the first electric potential,

e) calculating precisely the position of said positioning means, from said position of the drill bit, measured at step d), and thus the value of the uncertainty of said position with respect to said reference position.

Moreover, in the case of positioning means including pins, the steps described hereinbefore are preferably applied to determining the uncertainty of the position of said pins.

In another embodiment of the present invention, said pins are carried by a tool setting gauge, preferably of rectangular shape, and capable of being arranged on the workpiece carrier, above an elongated aperture arranged in the upper face of said carrier. The positioning means include in this case, in addition to the elongated aperture, mechanical means arranged in said elongated aperture and provided to co-operate with a part of the tool setting gauge for the purpose of fixing the latter on the workpiece carrier. The positioning of said elongated aperture, and thus said mechanical fixing means, consequently determines the positioning of the pins. It will be realised that it is then possible to determine the uncertainty as to the position of the positioning means with respect to a known reference position by precise measurement of the position of said elongated aperture, provided the precise dimensions of the tool setting gauge are known. In this case, according to a preferred embodiment, said uncertainty is determined by measuring the positions of at least three points belonging to at least two adjacent sides of the periphery of the elongated aperture.

Another alternative embodiment is provided to be applied to a machine-tool of the type including a plurality of operating units, which each carry a spindle enslaved to a certain work zone, which may or may not be delimited, on the workpiece carrier, the set of said operating units allowing the surface of said carrier to be integrally covered.

Generally, in such a configuration, the spindles participate in machining the same stack of printed circuit boards. Thus, the machining time is shortened. In this case, it is possible to carry out calibration, in order to ascertain the relative positions of said spindles by determining the position of a same reference point on the workpiece carrier, successively by said two spindles. If in this case the positioning means include at least two pins, steps a) to e) described above can be implemented, so that determination of the position of a first of said pins is carried out by a first of said spindles, whereas determination of the position of the second of said pins is carried out by said second spindle. Consequently, the uncertainty as to the position of said first pin is determined using said first spindle, whereas the uncertainty as to the position of said second pin is determined using said second spindle, which saves time for implementing the method according to the invention.

The invention will be better understood with the aid of the following description of an example embodiment made with reference to the annexed drawings, in which:

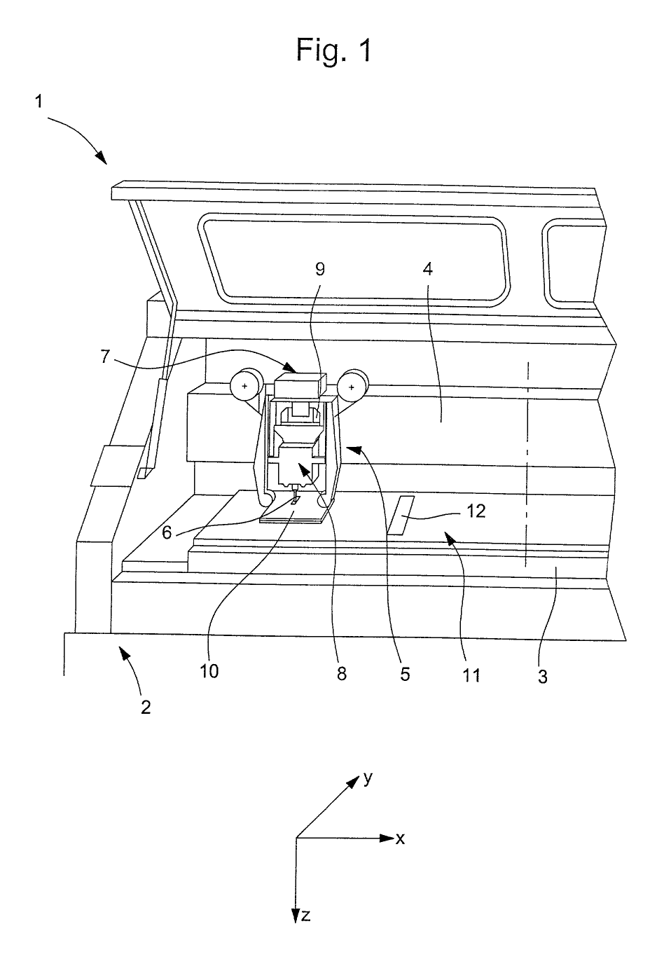

FIG. 1 is a schematic perspective view showing part of the constituent elements of a machine-tool for machining printed circuit boards;

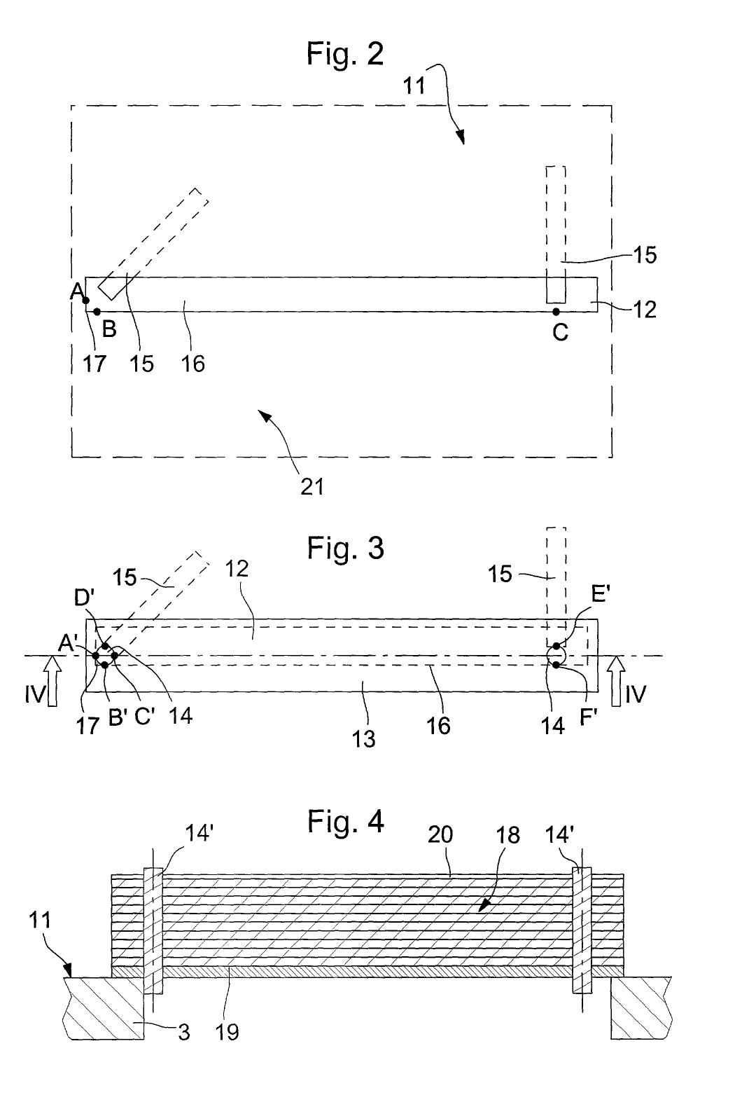

FIG. 2 is a schematic top view of an elongated aperture arranged on the workpiece carrier and forming part of the positioning means whose position uncertainty one wishes to determine according to the invention;

FIG. 3 is a schematic transparent top view of the positioning means shown in FIG. 2, the elongated aperture being covered here by a tool setting gauge carrying two positioning pins; and

FIG. 4 is a schematic transverse cross-section along the line IV-IV of FIG. 3, which also shows a stack of printed circuit boards intended to be machined after implementing the method according to the invention.

With reference first of all to FIG. 1, one can see an example of a machine-tool with which the method according to the invention can be implemented and which is designated by the general reference 1. Machine-tool 1 generally includes a base section 2 on which a workpiece carrier 3 is mounted and a fixed gantry 4 to which a plurality of operating units 5 are secured intended to drive a cutting tool 6, in this case a drill bit. For the sake of clarity, only one operating unit 5 has been shown in FIG. 1, the others being symbolised by dot-and-dash lines.

The machine of course includes conventional means to allow operating units 5 to move relative to workpiece carrier 3. In the example illustrated, workpiece carrier 3 is mounted so as to be able to move along the direction indicated by arrow Y in FIG. 1, operating unit 5 being mounted on gantry 4 so as to be able to move along the direction indicated by arrow X in the same Figure.

Machine-tool 1 is thus able to receive, via workpiece carrier 3, a plurality of stacks formed of printed circuit boards each including a stack of said boards to be machined and a bearing plate pinned together, so as to be machined simultaneously by operating units 5. Each of the stacks has its bearing plate which abuts the surface of workpiece carrier 3 and is secured thereto by conventional means (not shown).

Each operating unit 5 is mounted on gantry 4 via a support structure 7. A motorised spindle 8 which holds tool 6, here a drill bit, is also mounted so as to slide on a longitudinal guide 9 to be moved with respect to gantry 4 along a third direction perpendicular to directions X and Y and indicated by arrow Z in FIG. 1. Operating unit 5 further includes a conventional flank pressing device 10 mounted on support structure 7 and activated, for example, by means of two pressure cylinders (not shown) to press the printed circuit boards onto workpiece carrier 3.

Such a machine-tool generally includes a control unit including programmable electronic means (not shown) and enabling the operation thereof to be controlled, in particular the relative movements of operating units 5 and motorised spindles 8. Since these are conventional means, they will not be described in more detail in the present Application.

FIGS. 2 and 3 show a same enlarged view of the upper face 11 of workpiece carrier 3 allowing part of the positioning means to be visualised. Said face 11 includes an elongated aperture 12, of rectangular shape here, intended to be covered by a tool setting and positioning gauge 13 carrying positioning pins 14, generally two in number. Holes are provided in the stacks of boards to be machined to co-operate with similar pins, for the purpose of positioning said stacks on the workpiece carrier prior to the machining step. A known mechanical device is used to secure said gauge 13 onto said elongated aperture 12. Generally, tool setting gauge 13 is of rectangular shape and pins 14, usually cylindrical, are friction mounted thereon so that they have parts of similar length on either side of said gauge 13. In this manner, said mechanical device provided in elongated aperture 12 acts on the lower parts of pins 14, arranged in the elongated aperture, to block tool setting gauge 13 on workpiece carrier 3. In a known manner, said mechanical device includes in particular “fingers” 15 which grip the lower parts of said two pins, one against an edge 16 and the other against a corner 17 of elongated aperture 12.

Consequently, the respective positions of pins 14 are defined by the position and orientation of elongated aperture 12 as appears more clearly in FIG. 3. Indeed, FIG. 3 shows elongated aperture 12 of FIG. 2 covered by said tool setting gauge 13 carrying two pins 14 and held in place against a part of the periphery 16, 17 of said elongated aperture 12 by two “fingers” 15, pressing on the lower parts of said pins 14.

FIG. 4 shows the assembly described above in transverse cross-section, with in addition a stack 18 of printed circuit boards positioned on workpiece carrier 3. The structure of the stack of printed circuit boards 18 appears more clearly in this Figure, said plates being held together by pins 14′.

It will be noted in particular that the stack includes a base plate 19, generally made of cardboard, carrying said pins 14′ and that the latter have a distance between them which may be, but is not necessarily, the same as the distance between pins 14 of said tool setting gauge 13, the essential being that the position and orientation in the XY plane of the positioning means are precisely known. Consequently, said tool setting gauge 13 is used to simulate the presence of positioning means, so as to be able to implement the method according to the invention more conveniently than by using base plate 19 provided with pins 14′.

Pins 14′ are arranged in base plate 19 so as to have a part of their length above said base plate 19, to receive stack 18 of printed circuit boards and a lower part which interacts with the mechanical blocking device arranged in elongated aperture 12. It can also be seen in FIG. 4 that stack 18 of printed circuit boards is covered by an optional entry or cover plate 20, in particular assuring the protection of the first of the plates of said stack 18.

The method according to the invention allows the uncertainty as to the position of the means for positioning the stacks of boards to be machined on the machine-tool to be determined. Said positioning means include mainly, as appears from the description hereinbefore, elongated aperture 12 arranged in the upper face 11 of workpiece carrier 3 and pins 14′ carried by base plate 19.

In accordance with the preceding description, it is known that the position of stack 18 of boards to be machined depends directly upon the position of pins 14′ which itself depends upon the position of elongated aperture 12.

In order to determine uncertainties as to the positions of these different positioning elements, the method according to the invention relies on a technique known in the prior art, in particular by the name of “contact drill”. This technique, disclosed in German Patent No. 43 40 249 included herein by reference, used with machine-tools of the same type as those concerned by the present invention, in particular allows the drilling depth in multi-layered printed circuit boards to be accurately measured. For this purpose, the different conductive layers of said boards are brought to different electric potentials, preferably zero, while the drill bit is brought to a different electric potential, which is not zero. A measuring device, such as a voltmeter or a comparator is connected to said drill bit and thus allows its potential or the variation thereof to be monitored at any time. When, during the drilling step, the drill bit comes into contact with one of the conductors of said printed circuit boards, its potential is thereby modified, this modification being then detected by said measuring device. The amplitude of the variation in potential undergone by the drill bit can allow the layer of the board concerned with which the drill bit has come into contact to be determined.

Details concerning the electronic structure of machine-tool 1 and more particularly of the electronic measuring device will not be described more precisely, those skilled in the art can refer to U.S. Pat. No. 4,765,784 disclosing an example of such a device.

The method according to the present invention brings an improvement to the methods for machining printed circuit boards such as that described above in that it requires only slight technical modifications to a machine-tool using the “contact drill” principle to be implemented.

Indeed, tool 6, here a drill bit, whose position can be monitored precisely, remains the instrument for measuring the position of the various other elements which interest us on workpiece carrier 3, namely the positioning means. Consequently, in accordance with the preceding description, said drill bit 6 is brought to a first potential of determined value, preferably not zero. The various positioning means are respectively brought to electric potentials of different values from that of the drill bit potential, preferably all zero via a connection to earth. In this manner a contact, or proximity, between the drill bit and said positioning means generates a modification in the electric potential of the drill bit able to be detected by an electronic measuring device connected to the drill bit.

A first alternative implementation of the method of the invention is illustrated in FIG. 2. This first variant consists in determining the precise position of elongated aperture 12 on workpiece carrier 3, to deduce therefrom the uncertainty with respect to a reference position.

As is shown in FIG. 3, when the tool setting gauge is set in place on workpiece carrier 3 above elongated aperture 12, the pin 14 located at the front of the carrier is locked in a corner 17 of said elongated aperture 12 by the mechanical device, i.e. simultaneously along directions X and Y. At the same time, the pin 14 located at the back of the workpiece carrier only undergoes a lateral blocking, i.e. along direction X, against side 16 of elongated aperture 12 located on the same side as said corner 17.

It will thus be understood that determining uncertainty as to the position of the positioning means is the same as determining uncertainty as to the respective positions of said corner 17 and said side 16 of elongated aperture 12 with respect to reference positions. In order to do this, the periphery of said elongated aperture 12 has to be made of an electrically conductive material, so as to be able to be brought to an electric potential of well defined value different from that of the potential of drill bit 6 and preferably zero.

Once a reference position has been determined, the operator programmes a control unit so as to move operating unit 5, more precisely motorized spindle 8 holding drill bit 6 to reach one side of elongated aperture 12 forming said corner 17, in proximity to said corner, at the point noted A in FIG. 2. In a preferred embodiment, the electric potential of drill bit 6 undergoes a modification in its value at the moment an electric contact is established between drill bit 6 and said side of elongated aperture 12. One could however envisage using a capacitive or inductive type interaction mode rather than by electric contact. Said modification to the electric potential of drill bit 6 is then detected by the electronic measuring device, which then precisely calculates the position of point A from this measurement.

It may be noted that it is difficult to control the stopping of motorised spindle 8 so as to cause it instantaneously because of the inertia of said spindle 8. This is why the control unit is setup, in a known manner, so as to take into account the elasticity of tool 6 to calculate the speed of the movements of said spindle 8. Thus, this speed is selected so that the stopping distance, after detection of an interaction with one of the positioning means, is not greater than the maximum deformation that said tool 6 can undergo without exceeding its limit of elastic deformation.

After determining the position of point A, the control unit sends a signal to operating unit 5 to move drill bit 6 forward as far as second side 16 of elongated aperture 12 in proximity to corner 17, at point B noted in FIG. 2. The electric potential of drill bit 6 then undergoes another modification of its value at the moment that drill bit 6 enters into contact with point B, said modification again being detected by the electronic measuring device, which then calculates the position of point B precisely. Said measurements of the respective positions of points A and B allow the position of corner 17 of elongated aperture 12 to be determined with great precision and the uncertainty as to the position of said corner 17 to be deduced therefrom, by comparison with said corresponding reference position. These deduction and comparison steps are performed by the electronic means in a conventional manner and will thus not be developed any further.

The steps listed hereinbefore are then used again and applied to determining the position of point C shown in FIG. 2, then to determining uncertainty as to its position.

Knowledge of uncertainties as to the respective positions of points A, B and C thus allows the uncertainty as to the position of elongated aperture 12 with respect to a reference position to be determined.

It is clear from the foregoing that, because of its automatisation and management effected by the control unit, this method of determining uncertainty as to the position of the positioning means is relatively quick. Thus, depending on the result obtained, the machine operator can either continue the machining cycle without having lost much time, or have the position of the positioning means adjusted, if necessary, to respect the manufacturing tolerances. The speed and simplicity of the method according to the invention allow the operator of such a machine-tool to carry out the tolerance checks more frequently than with the manual methods of the prior art. Said operator is thus less likely to obtain defective printed circuits, because of the reduced risk of poor positioning of the stacks of printed circuit boards when they are being machined.

In another embodiment of the method according to the invention, said method is implemented once tool setting gauge 13 carrying pins 14 is arranged on workpiece carrier 3. This embodiment is preferred because pins 14 are arranged exactly like pins 14′ during a machining cycle. Insofar as said pins 14′ are directly in contact with stacks 18 of printed circuit boards, the accuracy of the position measurements of pins 14 thus depends on less uncertainties than in the embodiment previously described.

In the present embodiment, the operator has to programme the control unit so as to implement the following steps, partly illustrated in FIG. 3:

a) applying a first electric potential to drill bit 6, which is preferably not zero and a second electric potential, of different value to that of the first potential, and preferably zero, to pins 14,

b) measuring the electric potential of drill bit 6 with said electronic device so as to detect any change in its value,

c) moving drill bit 6 to the first of said pins 14, in order to measure the position of a point A′ on its periphery via the detection of the modification in the electric potential of drill bit 6 by the electronic measuring device, as described previously,

d) repeating the previous step to measure the positions of at least two additional points B′ and C′, preferably three B′, C′ and D′, on the periphery of said first pin 14,

e) calculating accurately the position of said first pin 14 from the previous measurements of the points on its periphery and thus the value of the uncertainty as to the position of said first pin 14 with respect to a reference position,

f) repeating steps a) to e) to determine the positions of at least two points E′ and F′ on the periphery of said second pin 14 then accurately calculating the position of said second pin and thus the uncertainty as to the position of said pin with respect to a second reference position.

As previously, depending on the result obtained, the machine operator can either continue the machining cycle without having lost much time, or adjust the position of the positioning means, if necessary, to respect manufacturing tolerances. Another alternative embodiment of the method according to the invention is provided more particularly for being applied to machine-tools of the type including a plurality of operating units 5. In this variant, the measuring steps described in the preceding variants are slightly modified in that the positions of the various parts of the positioning means are respectively determined by different operating units 5.

More precisely, in the case of a machine-tool 1 including two operating units 5 working on a same stack for example, the method described hereinbefore allowing the uncertainty as to the position of elongated aperture 12 is only slightly modified. It will be noted, as was indicated previously, that when two operating units are machining the same stack of boards, their relative positions are known precisely and the machining work is divided between them, each thus having its own machining programme. Consequently, the positioning means generally extend over a large part of work station 21 (FIG. 2), the position of one part of them is determined by a first of said two operating units, whereas the position of the other part is determined by said second operating unit, in particular in the event that the travel of one of said operating units is not sufficiently wide to reach the positioning means assembly.

The present variant is thus characterised with respect to the first in that determination of the positions of points A and B is carried out by a first of the two operating units 5, whereas determination of the position of point C is carried out by the second of the two operating units.

The method is completed like the preceding ones, i.e. by calculating the uncertainty as to the position of the positioning means, here the elongated aperture, with respect to a predetermined reference position.

The preceding description corresponds to preferred embodiments of the invention and should in no way be considered as being limited, as regards more particularly the nature of the tool used or the number of operating units arranged on said machine-tool. Indeed, it is common in this type of machine to have several operating units on the same zone, said operating unit spindles being dedicated to machining a stack of printed circuit boards for integrated circuits. In such case, of course, the method is to be applied independently to each pair of operating units.

What is claimed is

1. A method for determining uncertainty as to the position of positioning means of printed circuit boards with respect to a reference position for a machine-tool, in particular of the printed circuit board drilling machine type, said machine including positioning means for said boards with respect to an operating unit and programmable electronic control means for said machine, wherein determination of said uncertainty is achieved automatically by implementing said electronic means.

2. A method according to claim 1, wherein said operating unit includes a spindle carrying a drill bit, the method including the steps of:
a) applying a first electric potential to the drill bit and a second electric potential, of different value to that of the first potential, to at least a zone of limited spatial size of said positioning means,
b) measuring the electric potential of the drill bit so as to detect any change in its value,
c) moving said spindle to a distance from said zone so that a modification in the value of said first potential occurs because of its interaction with said second electric potential, said distance having been predetermined once and for all as a function of the nature of the drill bit and the potentials used,
d) measuring accurately the position of said spindle, then that of the drill bit, at the moment of said modification in value of the first electric potential,
e) calculating precisely the position of said positioning means, from said position of the drill bit, measured at step d), and thus the value of the uncertainty of said position with respect to said reference position.

3. A method according to claim 2, wherein said machine includes a workpiece carrier and wherein said relative movement of the operating unit occurs mainly in a plane parallel to said workpiece carrier, so as to calculate the position of the positioning means in the plane of said workpiece carrier.

4. A method according to claim 2, wherein said interaction between said electric potentials is of the type selected from among the group including interactions of the contact, capacitive and inductive type.

5. A method according to claim 3, wherein said interaction between said electric potentials is of the type selected from among the group including interactions of the contact, capacitive and inductive type.

6. A method according to claim 4, wherein said positioning means include at least two pins and wherein the uncertainty as to the position of said pins is determined by implementing steps a) to e) defined in claim 2.

7. A method according to claim 5, wherein said positioning means include at least two pins and wherein the uncertainty as to the position of said pins is determined by implementing steps a) to e) defined in claim 2.

8. A method according to claim 6, wherein said pins are of cylindrical shape, wherein said step of determining the uncertainty as to the position of said pins includes steps of measuring the positions of at least three points on the periphery of one of said pins and at least two points on the periphery of the other of said pins.

9. A method according to claim 3, wherein said positioning means include an elongated aperture arranged in said workpiece carrier and including at least a corner, said zone of limited spatial size being defined by the periphery of said elongated aperture, said positioning means further including a substantially rectangular base plate carrying pins oriented perpendicular to said base plate and provided to co-operate with holes arranged in said printed circuit boards, said base plate being capable of being positioned on said workpiece carrier above said elongated aperture in a predetermined manner and secured by a suitable mechanical device and wherein the uncertainty as to the position of said corner is determined by implementing steps a) to e) defined in claim 2.

10. A method according to claim 5, wherein said positioning means include an elongated aperture arranged in said workpiece carrier and including at least a corner, said zone of limited spatial size being defined by the periphery of said elongated aperture, said positioning means further including a substantially rectangular base plate carrying pins oriented perpendicular to said base plate and provided to co-operate with holes arranged in said printed circuit boards, said base plate being capable of being positioned on said workpiece carrier above said elongated aperture in a predetermined manner and secured by a suitable mechanical device and wherein the uncertainty as to the position of said corner is determined by implementing steps a) to e) defined in claim 2.

11. A method according to claim 7, wherein said positioning means include an elongated aperture arranged in said workpiece carrier and including at least a corner, said zone of limited spatial size being defined by the periphery of said elongated aperture, said positioning means further including a substantially rectangular base plate carrying pins oriented perpendicular to said base plate and provided to co-operate with holes arranged in said printed circuit boards, said base plate being capable of being positioned on said workpiece carrier above said elongated aperture in a predetermined manner and secured by a suitable mechanical device and wherein the uncertainty as to the position of said corner is determined by implementing steps a) to e) defined in claim 2.

12. A method according to claim 9, wherein said elongated aperture is rectangular and wherein it includes a step of measuring the positions of three points taken on at least two adjacent sides of said elongated aperture.

13. A method according to claim 11, wherein said elongated aperture is rectangular and wherein it includes a step of measuring the positions of three points taken on at least two adjacent sides of said elongated aperture.

14. A method according to claim 2, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.

15. A method according to claim 3, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.

16. A method according to claim 5, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.

17. A method according to claim 8, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.

18. A method according to claim 9, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.

19. A method according to claim 13, wherein said machine includes at least a second spindle carrying a drill bit and whose position is known accurately with respect to the first spindle, each of said spindles having its own machining programme, said positioning means having a significant spatial size and wherein the uncertainty as to the position of a first part of the positioning means is determined by implementing steps a) to e) defined in claim 2, by the first of said spindles and the uncertainty as to the position of a second part of the positioning means is determined by implementing steps a) to e) defined in claim 2, by the second of said spindles.
